(19) United States
(12) Patent Application Publication
(10) Pub. No.: US 2008/0212971 A1
(43) Pub. Date: Sep. 4, 2008

(54) Wireless Infrared Multimedia System

(76) Inventors: Tamir Shaanan, Herzelia (IL); Uri Kanonich, Hertzelia (IL)

Correspondence Address: JOHN ALEXANDER GALBREATH, 2516 CHESTNUT WOODS CT, REISTERSTOWN, MD, 21136, US

(21) Appl. No.: 11/995,704

(22) PCT Filed: Dec. 3, 2006
(86) PCT No.: PCT/IL06/01390

§ 371 Date: Jan. 15, 2008

Related U.S. Application Data
(60) Provisional application No. 60/751,428, filed on Dec. 16, 2005.
(60) Provisional application No. 60/780,442, filed on Mar. 8, 2006.

(51) Int. Cl. H04B 10/02

(52) U.S. Cl. 398/130

(57) ABSTRACT

A portable, data storage device, player, playback device, data streaming device, audio player, video player, audio and video player, satellite radio device, cellular phone (with an integrated audio and/or video player), PDA (personal digital assistant), PMP (portable media player), gaming device, handheld and/or mobile device, each embedded with inherent audio and/or video playing/playback capabilities, attached to a docking station or cradle via a single or plural audio/video connectors, wirelessly transmitting audio and/or video and/or control data via infrared optical signals to a set of remote wireless receiving device/s, speaker/s and/or video reproduction device/s.

### CROSS-REFERENCES TO RELATED APPLICATIONS

This application claims priority from, and the benefit of, applicants' provisional U.S. Patent Application No. 60/780,442, filed Mar. 8, 2006 and titled “Wireless Infrared Multimedia System”. This application claims also priority from, and the benefit of, applicants' provisional U.S. Patent Application No. 60/751,428, filed Dec. 16, 2005 and titled “Wireless Multimedia System”. The disclosures of said applications and their entire file wrappers (including all prior art references cited therewith) are hereby specifically incorporated herein by reference in their entirety as if set forth fully herein.

### FIELD OF THE INVENTION

The present invention relates to systems for wireless communication of audio and video, from a portable audio or audio/video data storage device/player contained in a docking station or cradle.

### DESCRIPTION OF THE RELATED ART

Today, with various types of portable audio data storage players, like the most common MPEG3 player (hereinafter “MP3 player”), (for example, an iPod® MP3 player from Apple Computers), one can purchase a docking station or cradle (hereinafter “DS/C”) for the MP3 player, which includes inherently, as part of the DS/C, speakers that serve as the audio reproduction device. The speakers are typically encased within the DS/C. One such device is disclosed in International Published Application WO2005/079448 (Grady).

Another similar example, which exists in the markets, is when the speakers are hooked to the DS/C (hosting the MP3 player) via wires, so that the speakers can be located farther from the DS/C for better stereo and/or surround hearing sensation and quality. One such device is disclosed in U.S. Published Application US2005/0105754 (Amid-Hozour). A similar device, although not showing speakers, is disclosed in U.S. Published Application US2002/0119800 (Jaggers et al.). As with Amid-Hozour's device, Jagger's docking station/cradle is not wireless. Instead, it uses wires to transmit the data to its output devices, versus the invention, which transmits the data to its output devices wirelessly.

A further existing example is when the MP3 player is attached to a mobile battery operated transmitter device (which, for example, uses Bluetooth technology), and then audio content is wirelessly transmitted to a set of headphones using the radio frequency medium.

A still further example is when the MP3 player includes internal wireless capability to enable direct wireless connectivity to the headphones.

Another still further example is when the MP3 player, hosted by a docking station or cradle, transmits the audio content wirelessly to a home audio system, and the home audio system is responsible for playing and amplifying the audio over a passive wired speaker set.

In addition, U.S. Published Application US2003/0054784 (Conklin et al.) and International Published Application WO01/29979 (Shaanan et al.) disclose the use of infrared in mobile telephone communications, in order to avoid the supposed health hazard issue related to radio-frequency (RF) signals being close to the user's head and to facilitate “hands-free” mobile telephone communication. However, these devices use bi-directional full duplex infrared communications utilizing two different infrared wavelengths, as they are intended mainly for full-duplex voice communications for a cellular phone. The present invention uses one infrared wavelength and does not use full-duplex communications, but rather one way, point to multi-point communications. Moreover, the Conklin device does not use diffused infrared, as in the present invention—and in fact there is no need to use diffused infrared in Conklin, because Conklin's application does not have the problem of blocking of infrared signals by an enclosure's various possibly obstructing objects, like furniture, passing people, etc. and by the particular placement of speakers within the room or enclosure.

Further, U.S. Published Application US2005/0015260 (Hung et al.) discloses an application device for playing of MP3 files, such that the MP3 data stored in a Universal Serial Bus (USB) device or a memory card can be directly played on a loudspeaker without a computer. However, there is no wireless transmission in this embodiment of Hung. A second embodiment of Hung provides an application device for MP3 that utilizes the standard frequency modulation (FM) stereo-audio system within an automobile to play MP3 audio data contained in a USB device or a memory card. Of course, this embodiment does not use infrared transmission means, and certainly not diffused infrared as in the present invention.

Further, U.S. Published Application US2004/0224638 (Fadell et al.) discloses a media player that can wirelessly transmit to various output devices. A docking station is also disclosed; however, this docking station does not have wireless transmission ability, and instead transmits data from the media player contained in it via wires to the output devices. In addition, the use of diffused infrared transmission is not disclosed.

Further, U.S. Published Application US2005/0018857 (McCarty et al.) discloses a system for communicating audio signals between an input device and an output device via a network. The communication can be wireless; however, the use of diffused infrared is not disclosed. Instead, McCarty's device attempts to solve the infrared line-of-sight problem by locating several infrared detectors on different surfaces of the infrared receiver housing, so that the infrared receiver can receive the signal transmitted from the infrared transmitter from more than one direction.

Finally, U.S. Published Application US2004/0223622 (Lindemann et al.) discloses a digital wireless loudspeaker system that includes an audio transmission device for selecting and transmitting digital audio data, and wireless speakers for receiving the data and broadcasting sound. However, RF transmission means are disclosed—not infrared, and certainly not diffused infrared as in the present invention. Lindemann's system also does not disclose or contemplate wireless video transmission.

In the first example given above, wherein the speakers are part of the DS/C and are typically encased therein, the result is an overall relatively large device/accessory that could be inconvenient to deploy on an office or living room table, a shelf, a cabinet, etc., because of lack of space. The space limitation issue is very important in certain household and office environments.

Also, when the speakers are encased in the DS/C, there is a limitation to the size of such speakers, and thus their respective quality and output power (there is a correlation between size and power/quality). The user potentially wants to hear the MP3 player's audio on larger, more powerful speakers, enhancing performance and overall sound sensation. If the speakers would be wirelessly connected via a wireless technology to the DS/C (in our case diffused infrared) then any power, separate mechanical design and architecture can be used for the speakers, enabling better flexibility, selection and benefit for the user.

### SUMMARY OF THE INVENTION

Thus it can be seen that it would be desirable to have a relatively small accessory (the DS/C), which hosts a portable audio data storage device (e.g. MP3 player), and have a set of wireless speakers detached completely from the DS/C as the audio reproduction device/s. Benefits are: a) space is saved, b) the DS/C is much smaller and more convenient to handle, and c) the user can benefit from a stereo and/or surround sound sensation from speakers that are set opposed him/her and with according size and power to his/her choice. That is, without the need to deploy audio wires/cables within the enclosure the system operates in. Deployment of wires is mostly a complex, annoying and inconvenient experience, as well as non-esthetic, or otherwise expensive deployment operation. There are thus advantages to deploying wireless speakers working with a wireless DS/C, with no communication cables/wires. Such wireless speakers termed active or powered wireless speakers need only a power supply connection via a standard power supply socket. Power supply sockets are abundant in various home/office environments.

It is thus a main intent of the disclosed invention with regards to audio reproduction to employ a set of wireless active speakers, which are wirelessly connected via infrared signals to the DS/C hosting the portable audio data storage player.

With respect to video content—the user can reproduce (through the wireless optical channel described herein) video content stored as data on the portable audio/video data storage player (as broadly defined above) to a larger screen Digital Television (DTV) (e.g. LCD, Plasma, etc.), or another type of viewer, projector, screen, or any other type of motion or still video reproduction device. The various devices would receive (over the infrared wireless optical channel) the video content as well as the related audio content, possibly in compressed format (or the video only in compressed format, for example in MPEG4 format or H.264 format), and de-compress it if necessary, as well as convert it to an analog video content (e.g. NTSC, PAL, HDTV) capable of driving the video reproduction device. The user can then enjoy his personal audio/video content on a large screen device with various viewing options and operators using the devices' regular remote control (RC) device. Again, the main benefit is that the link is wireless, i.e., annoying, non-esthetic audio/video wires/cables need not be deployed in order to reproduce the audio and video content to the audio/video (A/V) reproduction device. The audio and/or video system described above is generally termed the “wireless infrared multimedia system” (WIMS).

The user can now enjoy the convenience of deployment of a small docking station, hosting the portable audio or A/V data storage player within the room/enclosure. The user can re-deploy this small DS/C from room/office to room/office to enjoy personal A/V content in case wireless active speakers and/or a wireless audio/video device, like a DTV, are also pre-deployed in other enclosures (e.g. bedrooms, living room, kitchen, den, office and the like).

It is another aspect of this invention that the portable A/V data storage player hosted within the DS/C wirelessly transmitting to wireless audio and/or video devices serve as a multimedia center for the user, holding his personal audio/video content, possibly replacing or complementing the legacy home multimedia center, such as a home theater system, stereo system, video/DVD system, etc.

Another advantage of this system is that any user that owns a personal portable A/V data storage player can hook it up to any pre-deployed WIMS and share his personal audio and/or video content (e.g. a person visiting a friend that owns such WIMS).

With respect to the wireless infrared transmission means—specifically diffused infrared—used in the present invention. Wireless Infrared transmission has distinct advantages over radio frequency (RF) transmission in that:
a) It employs an optical carrier transmit signal and does not interfere with radio frequency operating devices (cellular phones, cordless phones, WLAN networks, etc).
b) It employs an optical signal receiver (e.g. a sensor, or array of sensors usually made of silicon), and is thus not susceptible to radio frequency interferences (from the same above RF devices, as well as the microwave oven, Bluetooth devices and the like).
c) Infrared's insensitivity to radio frequency interference means that it is particularly suitable for streaming type of audio, voice, and video communications systems, because significantly fewer (and possibly no) retransmits of data are needed. Thus latency is kept very low, and as a result, “lip sync” between the audio and video content (i.e., situations where the audio content is not aligned with the video content and, for example, a person is speaking but sound is delayed) is kept to a minimum. Accordingly, user satisfaction is higher with an infrared system. In addition, to address the significant interference and latency issues with RF, memory buffering or other techniques must be employed. This can make RF systems expensive, which is a major disadvantage in consumer electronics applications such as those described herein.
d) Infrared emissions do not go out of an enclosure they operate in, or just very mildly (optical signals do not trespass walls or other opaque objects), and so this type of technology has inherent segmentation, i.e., an infrared link, (for example embedded in a multimedia system) operating in one enclosure will not interfere with another such system operating in an adjacent enclosure (an enclosure being a room, office, SOHO, airplane cabin, vehicle, etc.). Multiple optical links deployed in different close enclosures can thus operate in full co-existence and utilize the same bandwidth (BW) in each enclosure (i.e. the concept of BW reuse). From this same reason optical infrared technology has inherent security, as no one can open an antenna in an adjacent enclosure and eavesdrop to the ongoing optical infrared communications. This is an important concept in the field of personal privacy for any type of communications.
e) Furthermore, optical emissions in the infrared wavelength (and specifically in the near infrared wavelength, which is proposed for usage for implementing the WIMS) is a worldwide non-regulated technology—it does not require any frequency allocations from countries or states, as well as any licensing or special labeling. When using an infrared light emitting diode (LED) as an emitter, which is also proposed for usage for implementing the WIMS), this technology may be labeled as a ‘Class 1 LED Product’.
f) Additionally, infrared technology is usually low cost in mass production quantities, and thus fits the above consumer electronic applications.
g) Furthermore, infrared emissions do not penetrate the body tissue as RF does (because of infrared's much shorter wavelength, very close to that of visible light) and so this technology, marketing wise, is alleged to be “greener” and safer for personal usage than RF (e.g., RF emissions are under continuous investigation for their long term effects—cellular emissions and other electro-magnetic emissions in various wavelengths).
h) In addition, the diffused infrared link of the present invention, wherein the link is completely omni-directional—i.e., fully non-directional and non-line-of-sight—has great advantages over conventional direct and semi-direct (wide angle) infrared links for the particular wireless multimedia system application disclosed herein. The diffused infrared link of the present invention behaves similarly to radio frequency based emissions within an enclosure and does not need a line of sight and specific directional positioning between the transmitting and receiving entities. Thus, the diffused infrared link of the present invention is very convenient for deployment in environments such as the living room, media room, den, dorm, audio/video room and the like because the link is omni-directional (diffused) and people can behave in a regular manner in this environment without disrupting the ongoing transmission of the wireless optical link. Further, the diffused infrared transmitter can be placed not in the direct line of sight of the diffused infrared receiver, and this allows for more flexibility in speaker placement, A/V source placement and furniture arrangement, etc.
   It is thus a preferred embodiment of this invention to use infrared based links and specifically the diffused infrared based link to implement the WIMS.

### DESCRIPTION OF THE DRAWINGS

FIG. 1 illustrates the embodiment wherein audio content from an Apple® iPod® MP3 player is transmitted via wireless diffused infrared to a remote speaker;

FIG. 2 illustrates the embodiment wherein audio content from a general MP3 player is transmitted via wireless diffused infrared to a remote speaker;

FIG. 3 illustrates the embodiment wherein audio content from a cellular phone with an embedded MP3 player is transmitted via wireless diffused infrared to a remote speaker;

FIG. 4 illustrates the embodiment wherein audio content from a satellite radio with an embedded audio CODEC (e.g. MPEG3 or similar) is transmitted via wireless diffused infrared to a remote speaker;

FIG. 5 illustrates an embodiment wherein audio and video content from an Apple® iPod® audio/video player is transmitted via wireless diffused infrared to a digital television and separate wireless speaker/s;

FIG. 6 illustrates an embodiment wherein audio and video content from an Apple® iPod® audio/video player is transmitted via wireless diffused infrared to a digital television with embedded wireless speakers;

FIG. 7 illustrates the internal architecture of the wireless infrared docking station for audio—that is, the docking station or cradle shown in FIG. 1;

FIG. 8 illustrates the internal architecture of the wireless active (i.e. powered) speaker using infrared transmission—that is, the speaker shown in FIGS. 1-5;

FIG. 9 illustrates the internal architecture of the wireless infrared docking station for audio and video—that is, the docking station or cradle shown in FIGS. 5-6;

FIG. 10 illustrates the internal architecture of the wireless infrared digital television—that is, the television shown in FIGS. 5-6;

FIG. 11 illustrates the internal architecture of another type of wireless infrared digital television usable with the system—a digital television with embedded speakers shown in FIG. 6.

### DETAILED DESCRIPTION OF THE INVENTION

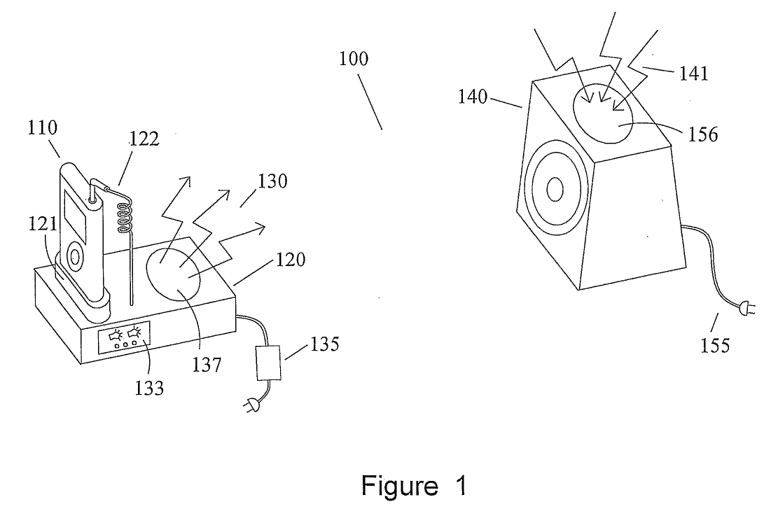

FIG. 1 depicts an audio only system embodiment of the Wireless Infrared Multimedia System (hereinafter, “WIMS”). System 100 is comprised of an iPod® player 110 (from Apple Computers of the U.S.) hosted in a wireless infrared docking station/cradle (hereinafter, “DS/C”) 120. DS/C 120 has generally a housing within which its electronics, connectors, cables, etc. are hosted. DS/C 120 retrieves audio content stored in player 110 through a digital connector 121 or an analog (e.g. line level audio) connector 122 (selectable by the user) and transmits wireless audio content over infrared transmission 130 to a single or plural wireless active speaker/s 140.

The wireless transmissions are transmitted through a “window” 137 either comprised from a transparent material (e.g. acrylic or polycarbonate) or from such same material doped with an infrared filter pigment/dye as used for a remote control receiver (e.g. a long pass optical infrared filter). The window is part of the mechanical structure of DS/C 120 housing and is needed to allow the optical carrier transmit signal to emanate from within DS/C 120. Wireless emissions from DS/C 120 arrive as infrared signals 141 (typically attenuated and distorted) to wireless active speaker/s 140 and enter the speaker through a similar window 156. The material for window 156 is, as explained above, doped with a pigment/dye so as to allow only infrared transmission to pass through while attenuating visible light existing in the ambient light environment. Wireless active speaker/s 140 uses infrared signal 141 for reception of the audio data carried over the wireless optical channel to produce an audio out sound/music signal to the environment. Each speaker 140 is active or powered (i.e. includes an internal power supply) and needs only to be connected to an electricity supply socket (i.e., mains supply) via an electric cable 155.

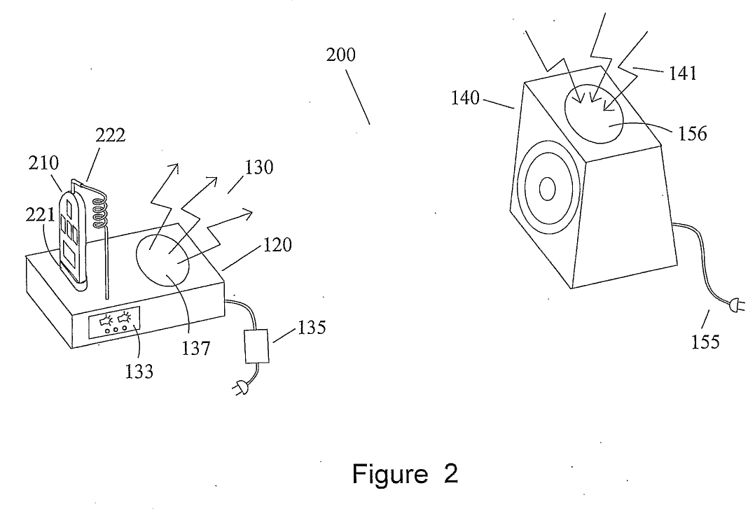

FIG. 2 depicts a very similar audio only system preferred embodiment of the WIMS marked as 200. In this system iPod® player 110 is replaced by general MP3 player 210. All of the rest of the system elements remain the same, except that digital and analog connectors 221 and 222 respectively may be changed to provide for the correct needed connection to MP3 player 210. MP3 players are manufactured by companies such as Sandisk (U.S.), Microsoft (U.S.), Creative Labs® (Singapore), Sony® (Japan) and many others.

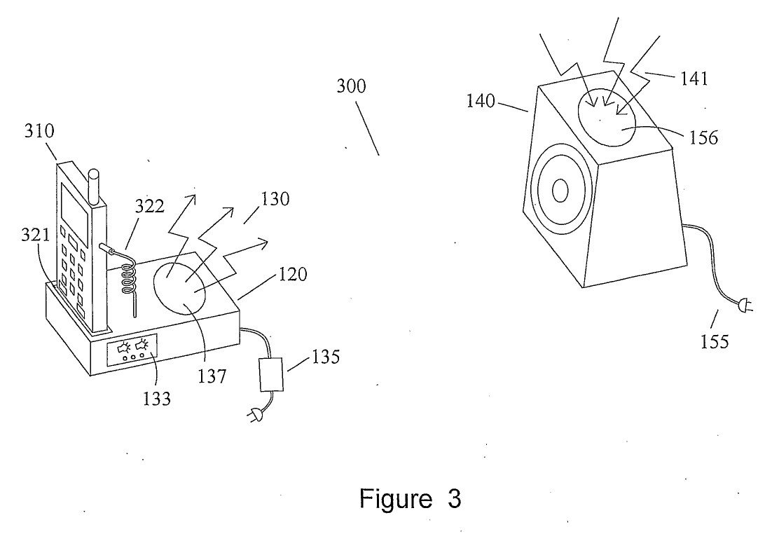

FIG. 3 depicts still another very similar audio only system preferred embodiment of the WIMS marked as 300. In this system iPod® player 110 is replaced by a cellular phone with embedded MP3 player 310. All of the rest of the system elements remain the same, except that digital and analog connectors 321 and 322 respectively may be changed somewhat to provide for the correct needed connection to cellular phone's 310 audio output. Cellular phones with inherent MP3 player capabilities are manufactured by Nokia® (Finland), Sony®-Ericsson® (Japan/Sweden), Motorola® (U.S.) and others.

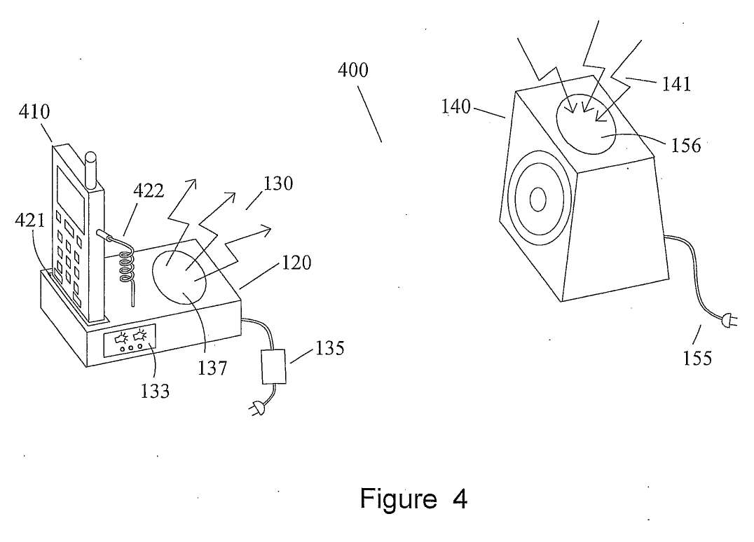

FIG. 4 depicts still another very similar audio only system preferred embodiment of the WIMS marked as 400. In this system iPod® player 110 is replaced by a satellite radio 410. All of the rest of the system elements remain the same, except that digital and analog connectors 421 and 422 respectively may be changed somewhat to provide for the correct needed connection to satellite radio 410 audio output. Satellite radio devices are manufactured by companies such as XM™ and Sirius®, both of the U.S.

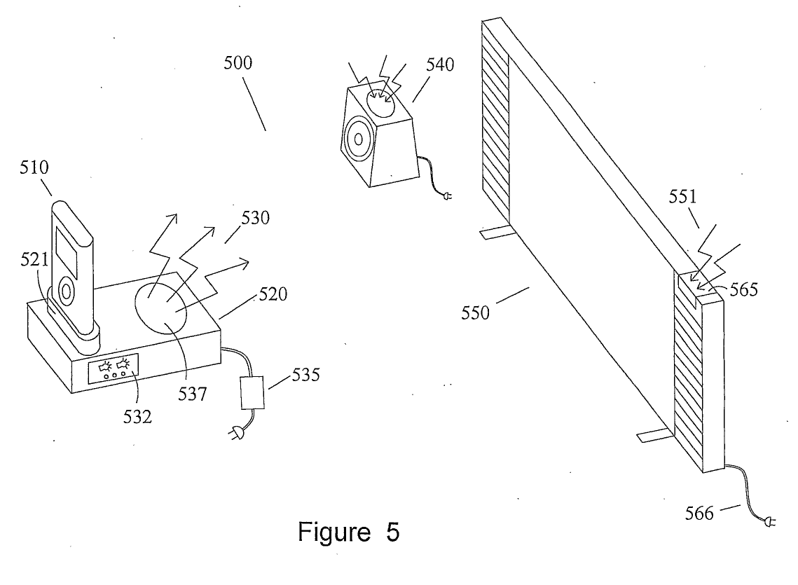

FIG. 5 depicts an audio and video (A/V) system embodiment of the WIMS. System 500 is comprised of an iPod® video player 510 (from Apple Computers of the U.S.) hosted in a wireless infrared docking station/cradle (DS/C) 520. DS/C 520 has generally a housing within which its electronics, connectors, cables, etc. are hosted. DS/C 520 retrieves audio and video content from player 510 through digital connector 521 and transmits wireless A/V content over infrared transmission 530 to a wireless home theater system comprised of a wireless digital television (hereinafter, “DTV”) 550 and at least one wireless active speaker 540 (a set of wireless active speakers may also be used). Wireless active speaker 540 is of similar build and architecture as wireless active speaker 140 shown in FIG. 1, except that it is capable of extracting the audio only content from the wireless A/V stream within its internal processing units.

Infrared transmissions 530 (carrying wireless A/V content) are transmitted through a window 537 with function and materials similar to window 137 of DS/C 120. Wireless emissions from DS/C 520 arrive as infrared signals 551 (possibly attenuated and distorted) to wireless DTV 550 and enter the DTV through a window 565. Wireless transmissions also potentially arrive at wireless active speaker 540 through its infrared window. The window material, in both the wireless DTV 550 and wireless active speaker 540, is, as explained above, doped with a pigment/dye so as to allow infrared transmissions to pass through and to strongly attenuate any visible light existing in the ambient light environment (e.g. a long pass optical infrared filter).

Wireless DTV 550 uses infrared signal 551 for reception of the digital video data, producing a motion picture for display on its screen. Wireless DTV 550 is connected via electrical cord 566 to a mains power supply. Wireless active speaker 540 uses infrared signal 530 for reception of the digital audio data carried over the infrared transmission and produces an audio out signal to the air medium. Wireless active speaker 540 includes an internal power supply, and needs only to be connected to an electricity supply socket via an electric cable for its operation.

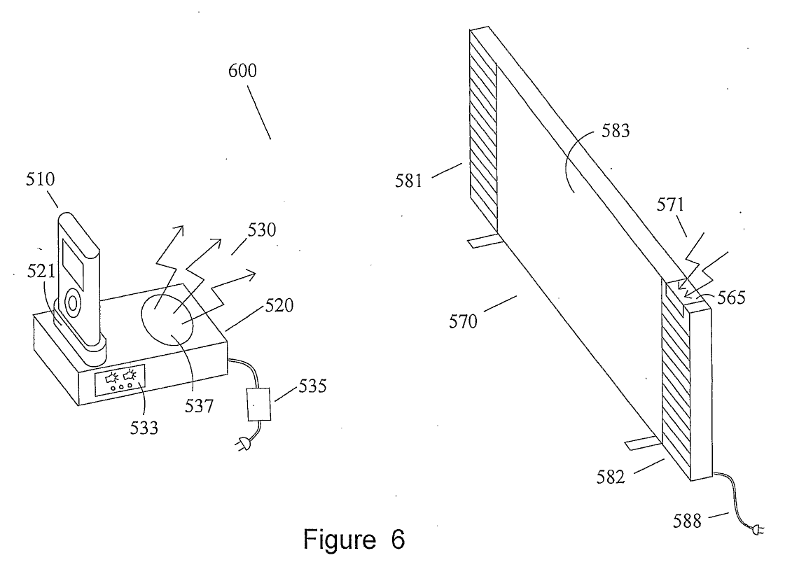

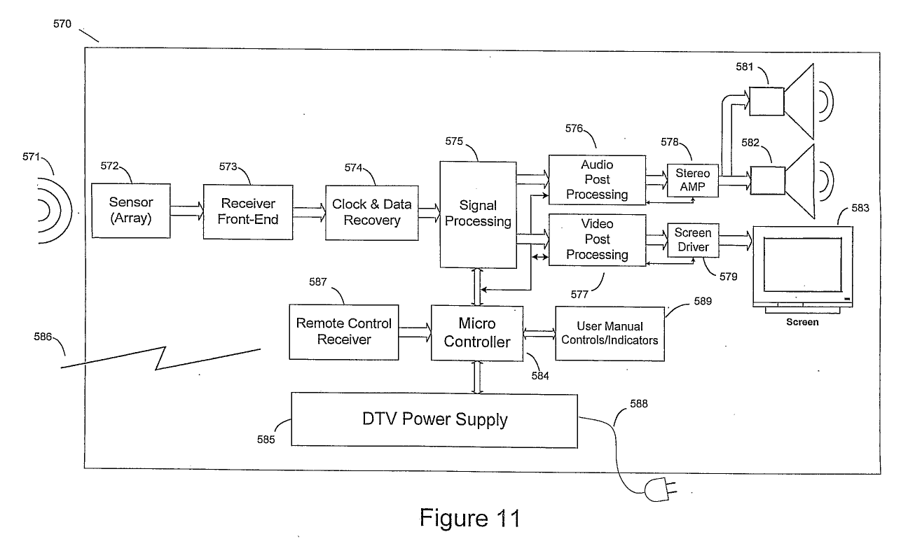

FIG. 6 illustrates system 600, which is another similar embodiment to the above wireless audio and video wireless infrared multimedia system. In system 600, the speaker entities are encased (embedded) within Wireless DTV 570. This can be performed in many ways, for example on the two sides of wireless DTV 570. In this case, the infrared signal 571 is received at infrared window 565, then the DTV electronics shown in FIG. 11 separate the audio and video signals to wireless DTV 570's embedded speakers 581 and 582 and screen 583 respectively.

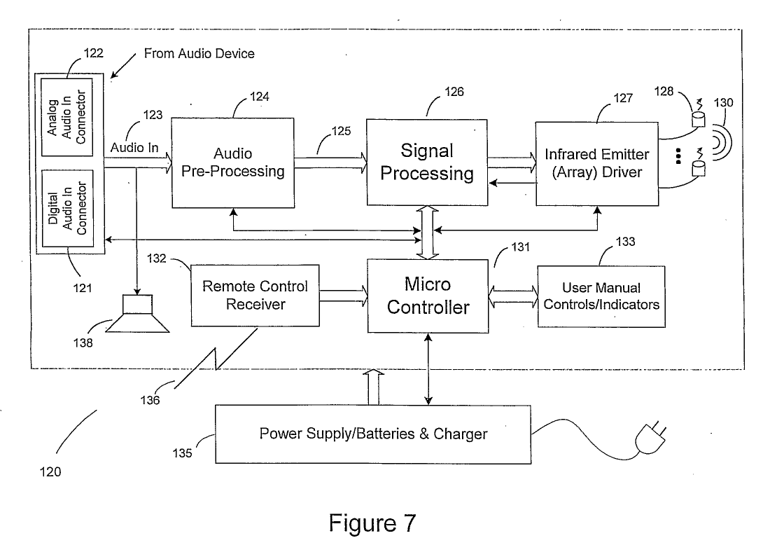

FIGS. 7-11 describe in detail the internal electronic architecture of the audio and A/V embodiments of DS/Cs 120 and 520 respectively; wireless active speakers 140 and 540 respectively; the wireless DTV 550; and the wireless DTV with embedded speakers 570. A detailed description of each figure follows.

It should be understood that the above portable audio and or video data storage players can also be replaced by various other portable audio and/or video data storage player devices like a personal digital assistant, a gaming device or a portable media player (PMP). It should also be understood that MPEG3 is just one form of an audio CODEC that can be included in a portable audio data storage player. Instead of MPEG3, the audio CODEC could be of AAC or WMA format compressed audio, or another suitable format.

It should also be understood that the DS/C as part of the WIMS for audio only or for A/V applications may be comprised of various mechanical and industrial design (ID) configurations (e.g. mechanical structure and connectors) to be able to host the above described devices of various sizes and form. The connectors can also assume various mechanical and electrical attributes as needed and desired by the specific implementation of the DS/C.

FIG. 7 depicts the internal architecture of the audio-only wireless infrared docking station/cradle embodiment 120 of the invention. Docking Station/Cradle (DS/C) 120 is connected to either an iPod®, MP3 player, cellular phone with embedded MP3 player, satellite radio device, PDA, PMP or gaming device, referred to by the general term “the Player” from hereon. DS/C 120 includes 2 types of audio connectors: a) An analog audio in connector 122, which inputs what is known as analog line level audio from the Player. b) A digital audio in connector 121, which inputs digital type audio from the Player (typically PCM-I²S). The digital audio data is optionally compressed audio data (e.g. MP3). The analog or digital audio data may optionally include embedded volume or other audio attributes. The type of audio input (i.e. analog or digital, if existent) is selectable by the DS/C user through user manual controls 133 or by remote control 132 (see later).

After selection, audio signal 123 is input to audio pre-processing unit 124 of DS/C 120. Audio signal 123 may optionally be comprised of a few audio channels (e.g. 1, 2 or more pairs of L and R channels). Audio pre-processing unit 124 may be optionally comprised, as one example, from an audio grade analog to digital converter (ADC) circuit for processing an analog type audio input from the Player. The ADC samples the incoming analog audio signal and converts it typically to a digital pulse code modulated signal (PCM) 125 (e.g. in I²S format). The ADC may assume various types of functionalities/performance, for example its total harmonic distortion or SNR. Example audio grade ADC devices are from Texas Instruments® (PCM1800) and Cirrus Logic® (e.g. CS5351), both from the U.S.

Audio pre-processing unit 124 may also receive digital type audio in compressed or non-compressed formats. It can then process this signal in various manners. For example, for non-compressed digital audio data, audio pre-processing unit 124 can convert it to various types of PCM signal formats, or perform re-sampling by an SRC (Sample Rate Converter) circuit (e.g. from 44.1 KHz to 96 KHz sampled audio). Or optionally, audio pre-processing unit 124 can compress the digital audio data to reduce wireless channel bandwidth limitations, and eventually transmit the compressed digital audio data to a wireless active speaker where decompression will take place. Audio pre processing may also involve manipulations of signal's volume, bass and treble attributes using various types of digital based algorithms (e.g. filters). Audio pre-processing unit 124 may optionally be controlled by microcontroller unit 131 directing it to use various parameters in processing the arriving analog or digital type audio signals.

The next unit in the DS/C 120 electronic architecture is signal processing unit 126. This unit is the central processing unit of the DS/C, receiving digital type audio signal 125 and preparing it for transfer to unit 127, the wireless front end circuit. Unit 126 optionally performs various digital signal processing (hereinafter, “DSP”) operations on incoming digital type audio signal, whether in non-compressed or compressed format. DSP performed within unit 126 may optionally include: data concatenation; data scrambling; data encryption (e.g. DES); digital audio data compression (e.g. lossless compression techniques for reducing needed channel bandwidth); modulation, either carrier frequency modulation technique (e.g. FSK, BPSK, QPSK, and the like, optionally over a high rate electronic carrier frequency), or baseband modulation technique (e.g. L-PPM, HHH and the like); data framing and formatting (e.g. splicing into equal sized data frames and adding various types of headers, preambles and delimiters); and addition of clocking information for wireless signal synchronization.

Digital signal processed data is then fed to unit 127, which is the transmit side wireless front-end circuit. This unit is an infrared emitter (optionally emitter array) driver and uses the air medium to transmit wireless data to receive side entity/ies. Unit 127 employs an optical carrier transit signal with a single optical frequency. Optionally this optical frequency is in the near infrared (NIR) band (e.g., using 850-880, 950, 1050, 1300, or possibly 1500 nano-meter wavelengths). The physical nature and configuration of this infrared transmission may optionally be direct and narrow angle transmission (e.g. similar to a remote control or an IrDA link); direct and wide angle transmission; or non-direct and non-line-of-sight (NLOS) optical infrared transmission, which is known as diffused infrared. Diffused infrared is also sometimes referred to as omni-directional infrared.

Unit 127 may optionally employ driving circuits (e.g. a driver transistor) for driving a single or plurality of electro-optical infrared transmission devices 128 like a LED—light emitting diode, a LASER diode or a LASER device or a certain combination of these devices, which are commonly and collectively referred to as communication diodes (hereinafter, “CDs”). The driving circuits may optionally use techniques to keep average current signal stable, as well as to regulate other important parameters of the driving circuits and the infrared emitters.

Specifically, conventional communication diode driver circuits (hereinafter, “CDDCs”) are designed to illuminate CDs at about 90% of their maximum average LED drive current Iₘₐₓ (this less-than-maximum-level is hereinafter referred to as the nominal LED drive current I_{N}), so as not to shorten their lifetimes or cause malfunctions. However, power supply voltages can fluctuate by up to ±10%, which when compounded with the variances of CDs' forward voltages V_{f}, and their inherent temperature dependency, can often lead to either insufficient or over-increased actual LED drive currents I_{LED}(t). In the event that I_{LED}(t)<I_{N}, there is a resultant drop in CD light emission intensity thereby reducing the effective data transmission range, or in extreme circumstances precluding communication entirely. Against that, in the event that I_{LED}(t)>I_{N} for prolonged periods, a conventional CDDC drives its CDs with an excessive LED drive current I_{LED}(t), possibly shortening their lifetimes, or in extreme circumstances causing irreparable damage. Moreover, certain data transmission applications mandate relatively few or scarce digital data pulses arriving irregularly, and this makes it even more difficult for a conventional CDDC to accurately drive CDs.

In contrast, the communication diode driver circuits in Unit 127 selectively drive CDs in response to incoming digital data pulses with an LED drive current I_{LED}(t) where I_{LED}(t)=I_{N}±3%, and even more preferably I_{N}±1%, upon having settled into a steady state operation by virtue of incoming digital data pulses arriving at a relatively fast rate for a relatively long period of time. This is achieved by continuously providing a shift voltage SV(t) to one input terminal of a two input terminal shift amplifier whose other input terminal is fed with a pulsed analog data voltage ADV(t) corresponding to incoming digital data pulses for issuing a summed up pulsed drive voltage DV(t). The shift voltage SV(t) preferably increases up to a maximum value SVₘₐₓ after a long absence of incoming digital data pulses to ensure that an incoming digital data pulse leads to data transmission even in worst case scenarios, but conversely intermittently stepwise decreases on the condition that an actual LED drive current I_{LED}(t) instantaneously illuminating the CD(s) of a communication light emitting branch (hereinafter, “CLEB”), comprised of a few LEDs organized in a serial circuit, is greater than a nominal LED drive current I_{N}. The maximum value SVₘₐₓ is necessarily less than a threshold drive voltage for continuously illuminating a CLEB's one or more CDs.

The CDDCs in Unit 127 also process each single incoming digital data pulse independently without any stipulations regarding their rate of arrival or their adherence to any pattern of arrival, thereby ensuring that the CDDC is in the most prepared state possible for receiving the next incoming digital data pulse. Moreover, Unit's 127 CDDCs rapidly converge during a transient state to their steady state operation, and are highly robust to fluctuations in power supply voltage V_{CC}, individual CDs' forward voltages V_{f}, and ambient temperature changes (also affecting V_{f}), and thus are highly suitable for use in a wide range of data transmission applications. Furthermore, Unit's 127 CDDCs are sufficiently robust that they neither require screening of CDs nor any manual adjustment, for example, of a ballast resistor residing within the CLEB, and they enable the use of a low resistance sense resistor in series to a CLEB, thereby reducing local heat dissipation and related power consumption to a minimum.

The driver circuitry discussed above is important for diffused infrared (hereinafter, “DIR”). For example, since DIR incurs very strong attenuation in its path from the transmitter to the receiver entities, it is desirable for the infrared transmitter to drive the LED array in the most accurate manner possible (in terms of current), so that each WIMS unit that is produced performs similarly to the other WIMS units that are produced. If lower-accuracy drive circuitry for the LEDs is used, then the useful infrared energy, carrying the signal from the transmitter to the receiver, could vary significantly from unit to unit. This, compounded with DIR's very strong attenuation, could cause system range to vary significantly from WIMS unit to WIMS unit. Thus, one customer might get a system with one range and another customer might get a system with a significantly different range, and this would make it very difficult to “spec” the system reasonably for the general user. Indeed, without such accurate drive circuits a WIMS system using diffused infrared can be rendered useless for practical consumer electronic use. Only the tight control of the current of the CLEBs can ensure tight tolerances, consistency, and repeatability among different units coming off the production line. Tight control of CLEB current also ensures insensitivity to variance in external parameters like temperature, power supply, and forward voltage of the LEDs. In summary, the invention's specifically designed LED array drive circuitry is distinctly advantageous for wireless multimedia systems that use diffused infrared. Unit 127 may also optionally feed back digital signal indications to signal processing unit 126 as well as to microcontroller unit 131 (e.g. fault conditions). Eventually, DS/C 120 transmits an optical infrared transmission 130 to the single or plurality of wireless receiving devices. The signal is of one infrared wavelength and does not involve full-duplex communications, but rather is one way, from DS/C 120 to the single or plurality of wireless receiving devices.

DS/C 120 optionally employs a microcontroller sub-system (hereinafter, “MCS”) 131. MCS 131 boots up every time DS/C 120 is powered on and pre-programs various units in DS/C 120 like unit 126, unit 124 and unit 127 (the infrared emitter driver). These units optionally feed back information to MCS 131 (e.g. data rates flowing through the system, or fault indications). MCS 131 may also optionally interact with power supply/batteries and charger unit 135 for exchanging information (e.g. status information, for example, an over heating condition). MCS 131 may optionally receive user control information from two separate units, remote control receiver unit 132 and user manual controls/indicators unit 133. The DS/C user may control and interact with DS/C 120 in two manners: a) An infrared or radio frequency (RF) control signal 136 is sent to remote control receiver 132 embedded within the DS/C from a mobile transmitting remote control device. Remote control receiver 132 decodes the control signals received from the user and outputs them to MCS 131 for controlling DS/C 120 (e.g. shut down DS/C 120, mute certain audio channels, or change various system volume control settings). Digital control data (e.g. volume, treble, bass and the like) may optionally be passed to signal processing unit 126 for mixing with the processed audio frames in a seamless manner and then transmitted over the wireless optical channel to the wireless receiving devices for controlling their local parameter settings. b) DS/C 120 may also optionally include user manual controls/indicators unit for manual adjustment of DS/C controls (e.g. volume or bass control), as well as for receiving visual feedback from the DS/C (e.g. a small LCD screen or various indication LEDs—for example, “power good” or “standby mode”, or “error” indications). The user may choose to interact with the DS/C using these two units 132 and 133 or just one of these. MCS 131 may be further comprised of a memory module and further peripheral components usually accompanying MCS units, like input/output mechanisms, interrupt controller mechanisms and the like. DS/C 120 optionally comprises a connection (not shown) to the Internet or a PC, via dedicated connector/s and according cabling (e.g. USB) for audio content downloading directly to the Player. DS/C 120 may optionally also include a small built in speaker/phone device 138. When using a cellular phone 310, the user may receive an incoming cellular telephone call. MCS 131 detects this via interaction with cellular phone's digital audio connector 321, stops ongoing audio processing through the DS/C and directs incoming audio 123 to the speaker/phone, in order to reproduce the telephone call voice communication and hear the caller. The user may then also speak into the speaker/phone without picking up the cellular phone from the DS/C housing. DS/C 120 also employs unit 135—the power supply/batteries and charger unit. This unit may be encased in the DS/C or may be an external unit (e.g. a wall mount or desktop power adaptor/charger). Unit 135 is connected to a power supply socket and converts mains power supply to direct current (DC) voltages needed by DS/C 120. Unit 135 may optionally employ a set of rechargeable batteries for DS/C operation. In this case the unit includes also charger circuitry for charging the batteries from time to time.

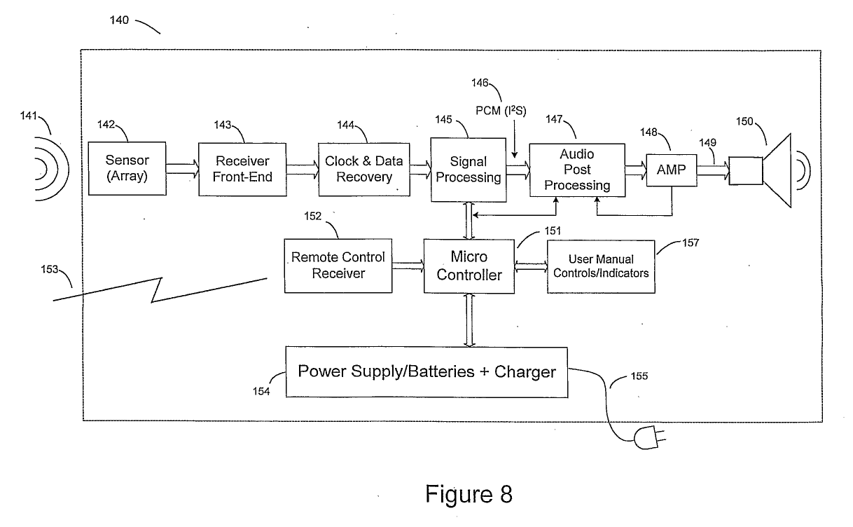

FIG. 8 depicts the internal architecture of the infrared based wireless active speaker embodiment 140 of the invention. Wireless active speaker 140 can assume the role of a wireless rear surround active speaker, a wireless subwoofer active speaker, a wireless active front speaker of the wireless infrared multimedia system or even possibly a wireless active center speaker. Wireless active speaker 140 receives infrared transmission 141 through its infrared window 156. These are received by a sensor entity 142 optionally built of one or a plurality of photodiodes (e.g. a sensor array). A photodiode converts an incoming optical power signal (carrying the information) to an electronic signal, which is then processed by subsequent circuits. Subsequent circuits optionally include a receiver front end 143 with a few central functionalities.

Receiver front end 143 comprises analog only, or ‘mixed signal’, analog and digital processing circuits, which may optionally include:
a) Low noise amplifiers (hereinafter, “LNA”) amplifying the sensor output signal into a signal worthy of further processing. Optionally the LNAs are built as trans-impedance amplifiers (TIA), converting sensor current signal to an amplified voltage signal.
b) Front end 143 may include a single LNA channel or a plurality of LNA channels, each attached to a single photodiode of the sensor array, as described above.
c) Optionally, front end 143 comprises an analog combiner that sums up the outputs of the plurality of Photodiode-LNA channels to receive a larger amplified signal.
d) Optionally, front end 143 includes a high speed sampling analog to digital converter (ADC) circuit to convert the analog signal as output from the combiner into a digital signal with a certain bit width (e.g. 8). Alternatively, the signal is continued to be processed in an analog fashion within the receiver front end.
e) Front end 143 may optionally include various types of filters (e.g. analog or digital) to filter out wireless optical channel noise and interference inherent in the ambient lighting environment. The filters may include, as an example, high pass filter circuits to mitigate electronic noise emanating from electronic ballast based fluorescent lamps. The filters may also filter out the electronic emissions of various types of remote control circuits and plasma TVs. Additional filters may then be used (e.g. low pass) to filter out high frequency noise inherent in the signal arriving from the optical wireless channel. If digital, the filters may assume the structure of a finite impulse response filter (hereinafter, “FIR”), as one example. An analog based implementation may comprise a passive or an active filter scheme (e.g. using operational amplifiers).
f) Front end 143 also typically includes an automatic gain control (hereinafter, “AGC”) circuit to allow for a relatively wide dynamic range operation of the WIMS. Wide dynamic range will allow the system to operate at a large scale of ranges between the transmitter and receiver sub-systems. The AGC may assume a fully digital, analog or mixed signal implementation scheme (e.g. a digital feedback control scheme).
g) Front end 143 may also include post amplification circuits to further amplify the signal before further processing.
h) Front end 143 may optionally include frequency down conversion circuits and other related circuits (e.g. in the case of implementing a carrier based frequency technique, as described above). Alternatively, in the case of baseband infrared processing (e.g. pulses), it will employ a thresholding (e.g. slicing) technique that comprises decision circuits operating based on certain received adaptive parameters from the environment (e.g. received signal strength).
i) Front end 143 may also include circuits to convert the signal to a certain format of digital output representation (e.g. LVDS, LVTTL and the like).

The next unit in the processing track is clock and data recovery (hereinafter, “CDR”) unit 144. This unit has a two fold operation. It may optionally include digital filter processing circuits to further enhance the signal to noise ratio (hereinafter, “SNR”) of the incoming signal (e.g. filter out foreign pulses in the case of baseband modulation technique). The other function is to extract and recover the clock signal inherent within the incoming data signal for sampling the incoming data signal at correct time intervals. Optionally CDR unit 144 employs phase locked loop (hereinafter “PLL”) circuits for generating a continuous resulting clock signal and after further processing (e.g. divisions, multiplications) feed it as the audio based clock to audio post processing unit 147, as discussed further below. CDR unit 144 may employ low jitter based techniques to ensure hi-fi audio reproduction quality. In this case, optionally the audio clocks of the transmit and receive side devices (i.e., DS/C and speakers) are made on the average identical, and thus no loss of audio samples and resulting signal distortion can occur.

The next unit in the track is signal processing unit 145. This unit is fed by digital data emanating from CDR unit 144. It is basically equivalent in function to unit 126 in DS/C 120, as described above but, whereby unit 126 is the encoder and modulator part of the WIMS, unit 145 is the decoder and de-modulator part of the this system. DSP performed in this unit may optionally include: employing carrier frequency de-modulation technique or baseband de-modulation technique matching the same techniques as described in the modulation section description of unit 126; data de-framing and assembly (e.g. stripping and acting upon the incoming data from non payload data information like preambles, headers and various types of delimiters, while using header data as various receiving device parameters); selection of specific audio channels (L+R) according to certain addressing schemes or header data information; data de-scrambling, data decryption, data decompression (e.g. lossless decompression techniques); sample rate conversion (SRC) for performing re-sampling of the audio data from one rate onto another; data format conversion, and the like. Digital output of this unit is fed to audio post processing unit 147. Optionally the format of digital data emanating from unit 145 is in pulse code modulated format (e.g. I²S audio signal 146).

Audio post processing unit's 147 function is to convert the decoded and de-modulated digital audio data received from signal processing unit 145 into a format that can drive an audio amplifier 148. The PCM input to this unit can assume different audio sample rates (e.g. 44.1 KHz, 96 KHz). Unit 147 can optionally be comprised from an audio grade digital to analog converter (hereinafter, “DAC”) circuit with various functionalities for outputting an analog line level audio signal to an analog amplifier 148. Example DAC devices for audio applications are Cirrus Logic® CS4340 and Texas Instruments® PCM1600, both of the U.S. Unit 147 can also optionally be comprised of a PCM to PWM converter/controller for converting the PCM signal to its pulse width modulated representation capable of driving a class D type amplifier 148 with PWM input. The controller may include various internal functions like inherent volume control programming, as well as other programmable DSP functions (e.g. soft mute) using digital algorithms (e.g. digital filters). Control for unit 147 may optionally be directed from: signal processing unit 145; MCS 151, as will be described later on; over the wireless optical channel from DS/C 120; via user type controls, or a combination of these. Unit 147 may optionally be controlled by MCS 151, directing it to use various parameters in processing the digital audio data. Unit 147 may return various indications to MCS 151, like, as an example, status information about amplifier 148 (e.g. temperature warning).

Amplifier 148 may optionally be an analog input, analog output type amplifier (e.g. class A/B amp.), for example LM1876 from National Semiconductor®; an analog input, class D output type amplifier, for example MP7722 from Monolithic Power Systems®; or a PWM input, class D type amplifier, for example MP8042 from Monolithic Power Systems®, both from the U.S. Amplifier 148 may assume various bridge type architectures (e.g. half bridge or full bridge), and capable of various output power (e.g., 20 Watt, 50 Watt, 100 Watt, etc.). Amplifier 148 may return feedback information to unit 147, as an example, overheating status indication.

Unit 150 is the acoustic speaker driver entity within wireless active speaker 140, which may be comprised of a bass sub-unit and a tweeter sub-unit, as an example, or several of these. Speaker driver 150 is fed by powered amplified signal 149 emanating from amplifier 148 as described above.

Infrared based wireless active speaker 140 may optionally employ microcontroller sub-system (hereinafter, “MCS”) 151. MSC 151 boots up each time speaker 140 is powered on and pre-programs various units within the speaker like units 145 and 147. These units may feedback digital signal information and/or parameters to the MCS (e.g. data rates flowing through the system or fault indications). MCS 151 optionally interacts with power supply/batteries and charger unit 154 (e.g. status information). MCS 151 optionally receives control information from two units, remote control receiver 152 and user manual controls/indicators 157. The user of the WIMS controls and interacts with wireless active speaker 140 in two manners. An infrared or RF control signal 153 is sent to remote control receiver 152 embedded within the speaker from a mobile transmitting remote control device. Receiver 152 decodes control signals received from the user and passes them to MCS 151 for controlling speaker 140 (e.g. speaker shutdown, or speaker volume settings). Speaker 140 optionally includes user manual controls/indicators unit 157 for manual adjustment of controls, as well as receiving visual feedback from the speaker (e.g. indication LEDs, for example, “power good” or “standby mode”, or “error” indications). The user may choose to interact with speaker 140 using these two units 152 and 157 or just one of these.

Speaker 140 includes unit 154—the power supply/batteries and charger unit. This unit is usually encased in speaker 140 but may also be an external unit (e.g. a wall mount or desktop power adaptor/charger) for small-mid sized powered speakers, for example <30 Watt. Unit 154 is connected to a power supply socket via cable 155, and converts mains power supply to various direct currents needed by the wireless active speaker. Unit 154 optionally employs rechargeable batteries for speaker operation. In this case the unit includes also charger circuitry for charging the batteries.

The whole of the electronic units of wireless active speaker 140 may optionally be encased in an external peripheral device with separate housing than the speaker/s, plugged to a mains power supply and feeding passive speakers deployed in the room via wires. A typical example would be a set of rear surround speakers. In this case, regular passive speakers (that have not been used due to wiring inconvenience) may use the external peripheral device with the above circuitry embedded inside (e.g. as an after market accessory) to feed them with wireless audio coming from across the enclosure.

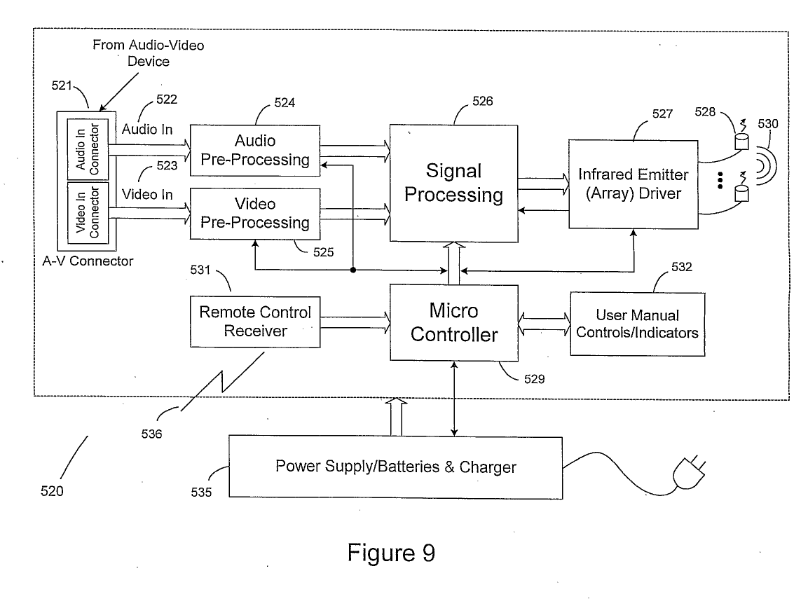

FIG. 9 depicts the internal architecture of the audio and video wireless infrared docking station/cradle embodiment 520 of the invention. Docking Station/Cradle (DS/C) 520 is connected to either an iPod® video player, or any other portable audio/video data storage player, referred to as “Video Player 510” from hereon. DS/C 520 has similar electronic circuits and functional architecture as DS/C 120, only that it additionally optionally processes streaming video data concurrently with streaming audio data.

DS/C 520 includes audio/video (A/V) input connector 521, which may be comprised of a single audio/video connector, or a separate connector for audio signal input and a separate connector for video signal input. Each of audio and video input connectors or a combined A/V connector may either input analog type signals or digital type signals. The analog or digital audio and video input signals optionally include embedded volume control and other inherent audio and video signal attributes, depending on the type of Video Player 510 used.

Audio input signal 522 and audio pre-processing unit 524 are similar in function and performance to audio input signal 123 and audio pre-processing unit 124 of DS/C 120 respectively and will not be discussed again in the detailed description for FIG. 9. Equivalent to audio pre-processing unit 524, DS/C 520 includes video pre-processing unit 525. Video signal 523 from Video Player 510 is input to video pre-processing unit 525 of DS/C 520. Video signal 523 is optionally digital in nature or analog in nature, whether in compressed (e.g. H.264 or MPEG4) or non-compressed format (e.g. NTSC, PAL or HDTV) respectively. Unit 525 is optionally comprised from a video grade analog to digital video converter. The converter operates on the incoming analog video signal and outputs a compressed digital video signal. The compressed format of the digital video is optionally H.264 or MPEG4.

Unit 525 can optionally receive non-compressed digital video data, and may then compress it using an according electronic converter device. Unit 525 can also optionally directly receive already compressed digital video data. When receiving non-compressed digital video data, or converting incoming analog video data to non-compressed digital video data, video pre-processing unit 525 may further operate in various ways on the digital non-compressed video data. For example, unit 525 may use motion video image enhancing operators like color conversion and algorithms, video data sharpening algorithms or video data image resizing operators for reducing the bandwidth of the digital video data stream and thus allow it to be transmitted over an infrared based wireless optical channel with limited communication bandwidth. Unit 525 may optionally compress the digital video data after it has operated on it using various motion video operators as described above.

Audio and video pre-processing units 524 and 525 are optionally controlled by MCS 529 directing them to use various parameters in processing the arriving analog or digital based audio and video data streams.

The next unit in DS/C 520 is signal processing unit 526. Unit 526 has equivalent function to unit 126 in audio only DS/C 120. Unit 526 accepts both pre-processed digital audio and video data and combines these streams into one stream of A/V data before it operates on this stream for preparation to sending over the wireless optical channel. Unit 526 may optionally provide for interleaved audio and video frames, may mix the data in another efficient way for sending over the wireless optical channel, or may even further compress the combined audio and video data stream. The output of this unit is fed to unit 527, the transmit wireless front-end circuit of DS/C 520, which is equivalent in nature and build to unit 127 in DS/C 120. A distinct difference may be that since combined audio and video data needs a larger bandwidth than audio data only, unit 527 comprises faster and higher bandwidth electronic circuits, as well as their related electro-optical devices, for transmitting the modulated and encoded data over the wireless optical channel. Unit 527 may optionally feed back signal indications to processing unit 526, as well as to MCS 529 (e.g. fault conditions). Eventually, DS/C transmits an infrared transmission 530 to the single or plurality of receiving devices.

DS/C 520 optionally employs a microcontroller sub-system (hereinafter, “MCS”) 529. MSC 529 boots up every time the DS/C is powered on and pre-programs various units in the DS/C like signal processing unit 526, audio and video pre-processing units 524 and 525 respectively and infrared emitter driver 527. These units may feedback digital signal information and parameters to MCS 529 (e.g. data rates flowing through the system or fault indications). MCS 529 may also optionally interact with power supply/batteries and charger 535 for exchanging digital data (e.g. status information, as also descried above). MCS may optionally receive control information from two units, remote control receiver unit 531 and user manual controls/indicators unit 532 in the same manner as described above for MCS 131 in DS/C 120. DS/C 520 employs unit 535—power supply/batteries and charger device having same functionality as unit 135 of DS/C 120.

DS/C 520 optionally comprises a connection (not shown) to the Internet or a PC, via dedicated connector/s and according cabling (e.g. USB) for audio and video content downloading directly to Video Player 510.

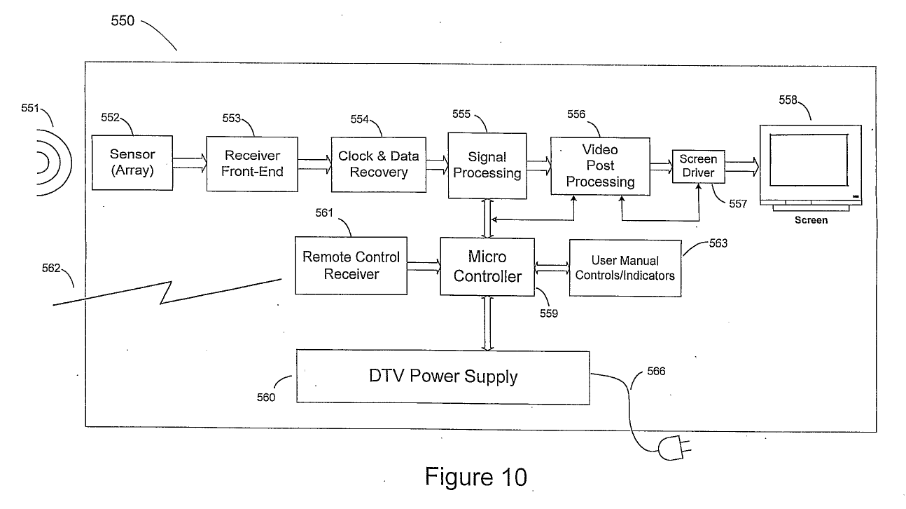

FIG. 10 depicts in detail an infrared based wireless digital television (hereinafter “wireless DTV”) embodiment 550 of the invention. Wireless DTV 550 can be an LCD TV, a Plasma TV (PTV), or a broader range of motion video reproduction devices like a projector, PC screen, gaming machine screen, etc. The internal structure of wireless DTV 550, broadly speaking, is similar to wireless active speaker 140. Sensor array unit 552, receiver front-end unit 553, CDR unit 554, signal processing unit 555, MCS unit 559, remote control receiver unit 561, user manual controls/indicators unit 563 and DTV power supply unit 560 are similar in build and function to units 142, 143, 144, 145, 151, 152, 157 (also all termed the same) and 154 respectively of infrared based wireless active speaker 140.

However, some internal circuits and performance parameters of these various units of wireless DTV 550 may be differently built versus wireless active speaker 140. For example, sensor array 552 may provide for higher bandwidth electro-optical devices so that high bandwidth digital video data can be sent over the optical channel; receiver front end 553 and CDR 554 may optionally also provide for faster rate circuits for wireless DTV operation, etc. Another important function is that signal processing unit 555 optionally discards audio frame data from the overall audio and video data streams for sending video only information to a screen.

Video post processing unit 556's function is to convert the decoded and de-modulated digital video data received from unit 555 into a format that can drive screen driver 557. The input to unit 556 is the digital video data from signal processing unit 555. Typically, unit 556 converts digital video data (possibly compressed) into an analog video signal (e.g. NTSC) for driving screen driver circuit 557. Unit 556 is optionally comprised of various internal functions like inherent color conversion schemes, as well as other programmable digital processing functions. Control for this unit may optionally be directed from signal processing unit 555 and/or over the wireless optical channel from DS/C 520 or via user type controls, like a remote control transmitter or local manual controls. Video post processing unit 556 may optionally be controlled by MCS 559 directing it to use various parameters in processing the arriving digital video data. Unit 556 may return various indications to MCS 559, as an example, status information about screen driver 557. Unit 558 is the screen entity of infrared based wireless DTV 550 driven by unit 557. It may employ various techniques as are known in the industry like LCD screen, plasma screen, OLED screen or other. Wireless DTV 550 optionally employs MCS 559, which boots up each time DTV 550 is powered on and pre-programs various units in wireless DTV 550 like signal processing unit 555 and video post processing unit 556. These units may feedback digital signal information and parameters to MCS 559 (e.g. data rates flowing through the system or fault indications). MCS 559 optionally interacts with DTV power supply unit 560 for exchanging data (e.g. status information). MCS 559 may optionally receive control information from two units, remote control receiver unit 561 and user manual controls/indicators unit 563 as described above.

FIG. 11 depicts in detail an infrared based wireless digital television (hereinafter “wireless DTV”) embodiment 570 of the invention. Wireless DTV 570 is similar in build and function to wireless DTV 550 except that two stereo audio speakers are encased within the wireless DTV and are part of its construction. In this case, wireless DTV 570 includes both an audio post processing unit 576 and video post processing unit 577 and their associated stereo AMP 578 and screen driver 579. Wireless DTV 570 includes screen 583 as well as two acoustic speakers 581 and 582 for left and right speaker sound reproduction. Signal processing unit 575 is similar in nature to unit 555 of wireless DTV 550, except that it processes, decodes and de-modulates combined audio and video data arriving from A/V DS/C 520. Signal processing unit 575 separates between interleaved digital audio and video data arriving from the wireless optical channel and processed in common by previous units in the processing track (i.e. units 572, 573 and 574) and feeds two different data streams—an audio data stream to unit 576 and a video data stream to unit 577. Unit 575 uses a-priori knowledge about the combining/interleaving method of audio and video frames to ‘de-frame’ the arriving data into separate digital audio and video data frame streams. All other functions of electronic circuitry of wireless DTV 570 are similar in function and architecture to wireless DTV 550. Wireless DTV 570 optionally requires larger bandwidth in its various processing units to provide for both audio and video data processing as opposed to video only data processing for wireless DTV 550.

While the above descriptions contain many specificities, these shall not be construed as limitations on the scope of the invention, but rather as exemplifications of embodiments thereof. Many other variations are possible without departing from the spirit of the invention. Accordingly, the scope of the invention should be determined not by the embodiments illustrated, but by the appended claims and their legal equivalents.

What is claimed is:

1. A wireless infrared data transmission system, comprising:
a) a portable data storage device containing data;
b) a docking station adapted to releasably engage with the portable data storage device, thereby gaining access to the data and being able to retrieve it;
c) a data receiving device adapted to wirelessly receive the data contained in the portable data storage device sent over a wireless optical channel; and
d) diffused infrared means for wirelessly transmitting the data in a one-way manner from the portable data storage device through the docking station over the wireless optical channel to the data receiving device, said means for wirelessly transmitting being located in the docking station and said means for wirelessly receiving being located in the data receiving device.

2. The system of claim 1, wherein said data comprises audio data, and said portable data storage device is an audio player.

3. The system of claim 1, wherein said data receiving device is encased within a speaker.

4. The system of claim 1, wherein said data receiving device is an external peripheral device.

5. The system of claim 1, wherein said system comprises a plurality of data receiving devices adapted to wirelessly receive the data contained in the portable data storage device.

6. The system of claim 2, wherein said audio data is digital.

7. The system of claim 2, wherein said audio data is analog.

8. The system of claim 2, wherein said audio player includes an audio codec.

9. The system of claim 1, wherein said data comprises audio data, and said portable data storage device is an audio player embedded within a cellular telephone.

10. The system of claim 9, wherein said audio player includes an audio codec.

11. The system of claim 1, wherein said data comprises audio data, and said portable data storage device is a satellite radio device with an embedded audio codec.

12. The system of claim 1, wherein said data comprises audio and video data, and said portable data storage device is an audio and video player.

13. The system of claim 12, wherein said audio and video player includes an audio codec and a video codec.

14. The system of claim 1, wherein said data receiving device is a digital television containing a speaker.

15. The system of claim 1, wherein said system comprises a plurality of data receiving devices adapted to wirelessly receive the data contained in the portable data storage device, and said data receiving devices include a speaker and a digital television.

16. A wireless infrared multimedia system, comprising:
a) a portable data storage device containing audio and video data;
b) a cradle having means for releasably engaging with the portable data storage device, thereby gaining access to the audio and video data and being able to retrieve it;
c) a data receiving device adapted to wirelessly receive the audio and video data contained in the portable data storage device sent over a wireless optical channel; and
d) diffused infrared means for wirelessly transmitting the audio and video data from the portable data storage device through the cradle over the wireless optical channel to the data receiving device, said means for wirelessly transmitting being located in the cradle and said means for wirelessly receiving being located in the data receiving device.

17. The system of claim 16, wherein said portable data storage device is an audio and video player.

18. The system of claim 17, wherein said audio and video player include an audio codec and a video codec.

19. The system of claim 16, wherein said data receiving device is a digital television containing a speaker.

20. The system of claim 16, wherein said system comprises a plurality of data receiving devices adapted to wirelessly receive the audio and video data contained in the portable data storage device, and said data receiving devices include a speaker and a digital television.
